(19) United States
(12) Patent Application Publication
(10) Pub. No.: US 2008/0126144 A1
(43) Pub. Date: May 29, 2008

(54) METHOD AND SYSTEM FOR IMPROVING THE ACCURACY OF A BUSINESS FORECAST

(76) Inventors: Alex Elkin, Littleton, MA (US); Scott Opitz, Media, PA (US)

Correspondence Address: BLANK ROME LLP, ONE LOGAN SQUARE, PHILADELPHIA, PA, 19103, US

(21) Appl. No.: 11/309,286

(22) Filed: Jul. 21, 2006

(51) Int. Cl. G06Q 10/00

(52) U.S. Cl. 705/7

(57) ABSTRACT

A method and system for improving the accuracy of the business forecast is introduced. The method is based on initializing the simulation by the actual state of the business process instances and using the historic data, adjusted by the deviations, as the simulation data feed. The computer system utilizing this method is proposed.

### BACKGROUND ART

Business Processes and Activities

Any enterprise executes a number of business processes whether defined explicitly or implicitly. As illustrated on FIG. 1, a business process consists of the business activities 10 and the transitions between them 20. For example, a retail store may have the business processes “Process Customer Order”, “Get Inventories from Suppliers”, “Process Monthly Payroll for Employees” and so on. The process “Process Customer Order” may include the activities “Display Catalog”, “Review Shipping Cart”, “Submit Order”, “Account Verification”, “Inventory Check”, “Order Shipping”, etc.

In many cases the individual activities or groups of activities are implemented as separate computer systems or applications. The applications interact with each other through the variety of interfaces, for example, event brokers, Web Services or API calls.

Any process may have a number of process instances. For example, the “Process Customer Order” process has a separate instance for every customer order being processed at any given time.

All process instances have a State. The state determines where this instance is in its execution. In most cases the state means the business activity that is currently under execution for that instance. For example, the current state of the “Process Customer Order” process instance for order #123456 is in “Order Shipping”. The process state may also include the values of some set of parameters, relevant for all elements of the process. For example, some processes may have “Start Date/Time”, “Order Number”, and “Order Total Value” as parameters whose values should be a part of the process state.

Forecast and Simulation

Use of simulation for forecasting the results of the business processes is well established. Companies like Rockwell Automation Inc., IDS Scheer AG and others provide comprehensive sets of tools for modeling business processes and related data and subsequent execution of the created models.

The accuracy of the simulation depends on several factors: a) The definitions of the business processes; b) The data feed for the simulation. The data feed includes many elements: the rate of new process instances, the values of the process parameters, the timing of transitions between the process states, etc.

Traditionally the data feed for simulation was defined manually by the users of the simulation programs. Such data were useful to find major problems or tendencies of the business processes but not suitable for accurate forecasting.

Another approach was proposed in patent application #20030233273 “Method and system for simulating a business process using historical execution data”. The method uses a data warehouse with historic data to feed the simulation engine with more realistic data that better represents real-world conditions. While this improves the accuracy of the simulation, several major issues still remain unresolved.

First, the historic data may not reflect the current execution of the business processes. The actual business condition at any given time may significantly deviate from historical trends. The deviation could be temporary or permanent, depending on the nature of the changes.

Second, new instances of business processes are often initialized by events outside the direct control of the company. For example, the rate of incoming orders for a retail store may depend on the weather, fashion, promotional campaigns, competition, etc. It is extremely unlikely that the historic data includes every unique combination of these many conditions.

### BRIEF DESCRIPTION OF THE DRAWINGS

FIG. 1 illustrates a simple business process as activities and the transitions between them.

FIG. 2 illustrates a plurality of instances of business processes at different states.

FIG. 3 illustrates the deviation of an actual value from the historic data.

FIG. 4 illustrates the different time patterns for a deviation.

FIG. 5 illustrates the symmetrical approach to defining the deviation time pattern.

FIG. 6 illustrates the components of the computer system implementing the method of the present invention.

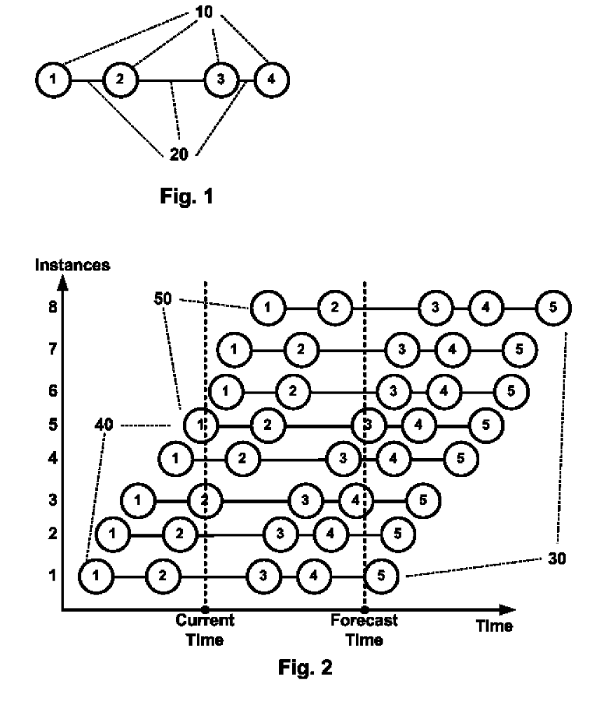

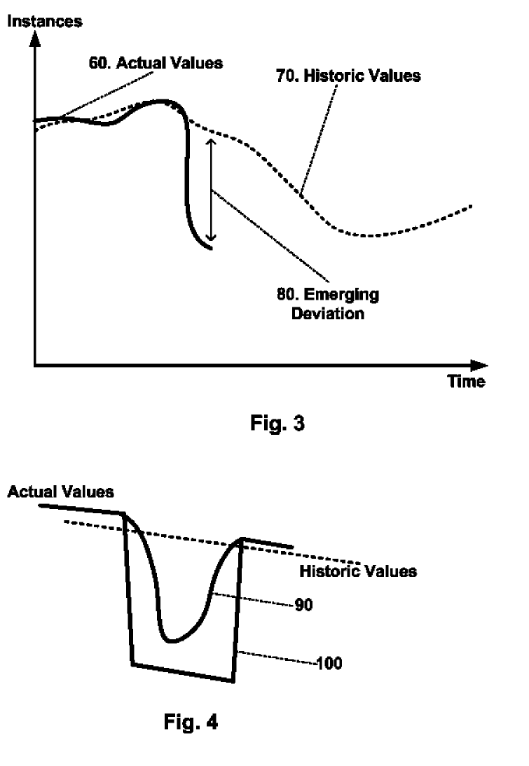

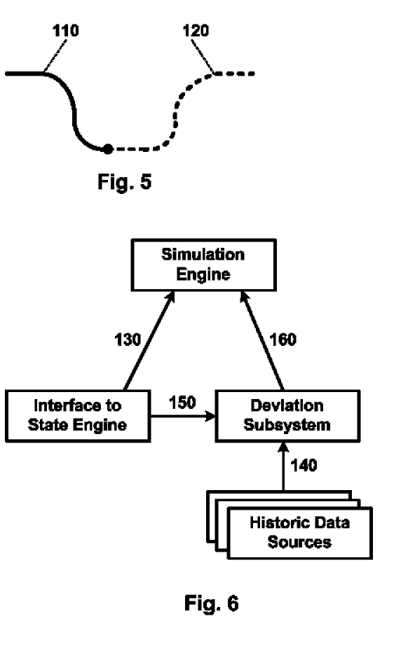

### DESCRIPTION OF THE INVENTION

The present invention provides a system and a method, implemented on a computer system, for more accurate forecasting of business results using process simulation. In order to increase the accuracy of simulation, the invention includes at least one of two elements: interface to the initial state of the business processes and a deviation control subsystem.

Interface to Initial State

The present invention uses the current state of the known instances of the business processes as a starting point for the simulation. The current state of the known instances is maintained by at least one computer system outside of the current invention and is obtained by the present invention through a plurality of interfaces. In one embodiment of the invention, the current state is read from the database; other embodiments may use computer communications between the invention and other computer systems or read the data from files generated by other systems.

The current state of the process instances includes all the processes at the various stages of their execution. As illustrated in FIG. 2, some process instances are just started while others are almost finished or anywhere in between.

Using the actual state of the processes as a starting point for the simulation dramatically improves the accuracy of the forecast. Indeed, as shown on the FIG. 2, the business results at the time “Forecast Time” are mostly determined by the process instances 1-5 already existing at the time “Current Time” of simulation start. It means most of the values for these process instances are not guessed or modeled but rather the actual values for those instances based on the actual state of the business at that point in time.

The length of the “window of accuracy” depends on the average length of the business process T_{process}. At any time T, the share of the process instances, existing at the time of the simulation start T₀ is (T−T₀)/T_{process}.

The values for new process instances should be modeled. Consider the accuracy of the modeling process as A_{model}<1. Using the present invention, the total accuracy could be estimated as A_{new}=(1−(1−A_{model})*(T−T₀)/T_{process}). For example, 1 week forecast for 2-weeks business processes with A_{model}=0.8, T_{process}=2 weeks, T−T₀=1 week, gives us A_{new}=1−0.*(½)=0.9. That reduces the error by 50%.

Using the same numbers, the 2 days forecast would provide accuracy of A_{new}=1−0.2*( 1/7)=0.97. Compared with original 0.8, the error is reduced more than 6 times.

The simulation initialization procedure could be repeated as often as required by the nature of the business. For example, a retail store can re-run the simulation every 10 minutes; initializing the simulation with the actual state of the processes, thus providing the consistent “window of accuracy”.

Deviation Control Subsystem

When the simulation starts, the Deviation Control Subsystem (DCS) analyses the historic data in order to calculate the values to be used as a data feed for the simulation. In one embodiment of the invention the values include the frequency of the new process instances, the average values and standard deviations of the process specific values (for example, the contents of the order), the time required for completion of the business activities and the transitions between them.

As the process instances advance from activity to activity and the new instances start, DCS calculates the same values and compares it with the historic ones. If one or more of the parameters deviates from its historic values, DCS generates the instance of deviation.

For every instance of deviation, DCS determines the time pattern. Time pattern is the time dependency of the value of the deviation. For example, the deviation value could stay constant until the reason for the deviation is removed; then go to 0. In other cases, the deviation value can gradually increase to a maximum, and then gradually decrease to zero. The time pattern for any deviation could be set by a user, or defined automatically by the system based on a variety of criteria. In one embodiment of the invention the time pattern for a deviation is assumed to be symmetrical, i.e. deviation ends at the same pace as it starts.

When the system executes the simulation, it adjusts the historic values for all parameters by all deviations which are currently active. In many cases, the value of deviations could be comparable to the historic values; thus the present invention will dramatically improve the accuracy of the simulation.

The computer system implementing the method of the present invention is illustrated on the FIG. 6. The system consists of the Simulation Engine which is initialized (130) by the Interface to the sources of the state of the process instances. The Deviation Control Subsystem (DCS) compares the actual business values (150) with the historic data (140) and determines the deviations. The historic data, adjusted by the deviations are used as a data feed for the simulation (160).

What is claimed is:

1. A method of improving the accuracy of the business forecast comprising the steps of:
Using the repetitive simulation of business processes as the mechanism of forecasting the business results;
Using the current state of all instances of the business processes as an initialization value for each iteration of the simulation;
Calculating the deviations of the actual values from the historic data;
Adjusting the historic data by all current deviations to achieve the optimal data feed values for the simulation.

2. The method of claim 1, wherein using the current state of all instances of the business processes as an initialization value for the simulation comprises obtaining the current state of the processes from a plurality of sources, converting it into the format suitable for the simulation and using it as a first step in next iteration of the simulation process.

3. The method of claim 1, wherein calculating the deviations of the actual values from the historic data comprises calculating the historic values from a plurality of datasources, obtaining the actual values from the execution system, detecting the deviation, and determining the deviation time pattern.

4. The method of claim 3, wherein determining the deviation time pattern comprises using a plurality of criteria including automatic rules and user decisions.

5. The method of claim 1, wherein adjusting the historic data by all current deviations as the data feed for the simulation comprises taking the historic data for the corresponding time and parameter and reducing or increasing it by the value of all deviations, active at that time.

6. The method of claim 1, wherein using the repetitive simulation of the business processes as the mechanism of forecasting the business results comprises executing the simulation initialized by the current state of the business process, then obtaining the new state of these processes through a plurality of sources, using the new data for initializing and executing each new simulation and repeating the procedure continuously.

7. A digital computer system implementing the method described in claim 1, the system comprises the simulation engine, the interface to the source of the current state of the business process instances and, optionally, the subsystem to detect and define the deviations from the historic values.
